(19) United States
(12) Patent Application Publication
(10) Pub. No.: US 2004/0096379 A1
(43) Pub. Date: May 20, 2004

(54) Nucleic acid library or protein or peptide library

(76) Inventors: Jens P Furste, Berlin (DE); Volker Erdmann, Berlin (DE)

Correspondence Address: Mark D Wieczorek, 2nd Floor, 251 North Avenue West, Westfield, NJ, 07090, US

(21) Appl. No.: 10/344,335

(22) PCT Filed: Aug. 10, 2001
(86) PCT No.: PCT/DE01/03067

(30) Foreign Application Priority Data
Aug. 11, 2000 (DE) 100 40 857.5

(51) Int. Cl. B01D 9/00

(52) U.S. Cl. 422/245.1

(57) ABSTRACT

The invention relates to a nucleic acid library or protein or peptide library in the form of a two-dimensionally resolved grid-type arrangement with a plurality of grid elements. Every grid element contains, on the statistical average, a defined number of nucleic acid types or protein or peptide types having a respective specific sequence structure. The inventive library is further characterized in that the grid elements are configured as capillary hollow spaces. The capillary axes of said capillary hollow spaces are in parallel to one another and the openings of different capillary hollow spaces are arranged in a grid area. The invention further relates to various uses of such a library.

### FIELD OF THE INVENTION

The invention relates to a nucleic acid library or protein or peptide library in the form of a two-dimensionally resolved grid-type arrangement with a plurality of grid elements, every grid element containing, on the statistical average, a defined number of nucleic acid types or protein or peptide types having a respective specific sequence structure, to a method for preparing such libraries and to the use thereof.

As a library is understood a heterogeneous population of nucleic acids or proteins or peptides immobilized in the grid elements. Heterogeneous means that different nucleic acid types or protein or peptide types with different sequence structures are distributed in the grid elements in a defined position-resolved manner. Position-resolution means that with the position of a grid element, an information about the sequence or the sequences of a substance present therein or several substances present therein is correlated. The defined number may be 1 to 100, preferably 1 to 50, most preferably 1 to 10, in particular 1. In the latter case, only nucleic acids or proteins or peptides of one and the same sequence are contained in a single grid element (or none of these substances; empty grid element). Immobilized means, in this context, that the nucleic acids, proteins or peptides cannot easily move out of the grid elements. Nucleic acids may be RNA and DNA, but also PNA. The nucleic acids, proteins or peptides may be natural or fragments of such natural substances, it is however also possible to use non-natural substances. In the case of nucleic acids, the spiegelmers are to be mentioned here. But chemically modified derivatives also belong to the non-natural substances, same as non-natural sequences.

### BACKGROUND OF THE INVENTION

Substance libraries are used in many sectors, for instance the molecular biology and drug discovery. In the case of the nucleic acid libraries, they serve, among other purposes, for researching the functions of genes, for instance coded in EST's, and that with a high throughput. In the case of the protein or peptide libraries, they serve for instance in high capacity screening methods for discovering highly affinitive and highly effective pharmaceuticals. Here, in particular combinatorial libraries are used. Substance libraries may however also be used for screening and detecting physiological malfunctions, for instance caused by mutation, of a patient in a very broad width and effectivity. Further, for instance by expression comparison, valuable information about genetic variants can be obtained.

One problem of substance libraries is the preparation and in particular individualization of the individual compounds or compound types. This applies in particular to the protein and peptide libraries, the synthesis of the individual compounds being time-consuming and determining the overall speed. Another problem is the preparation of the position-resolved immobilized system with the individual substances. In general, sequential methods are used here, which are, in particular for high populations of the libraries, for instance 10³ to 10⁹, extremely time-consuming and expensive. Sequential means that the grid elements are successively loaded with the associated substances.

### PRIOR ART

From the document Proc. Natl. Acad. Sci., 87: 6296, 1990, it is known in the art to dilute a mixture of alleles in dilution sequences so far that in the dilution fractions there is only one DNA molecule each left. These molecules can then again be amplified and analyzed.

From the document Nucleic Acids Res., 26: 4339, 1998, a basically similar method is known in the art, wherein for each dilution product one element of a 384 well plate is provided. After the amplification, a transcription/translation is performed, with a protein library as a result. Without any further reference, the application of the chip technology is mentioned.

From the document U.S. Pat. No. 5,641,658, the so-called bridge technology is known in the art, by means of which in a sample certain amplification targets can be detected. For this purpose, a grid, for instance 10×10, is arranged on an areal support, and within each grid element, two primers specific for a target are bound with 5′ to the solid phase. If targets correlated with the grid elements are present in the sample, amplifications take place within the grid elements.

The amplification factor is limited by the number of the primer molecules within a grid element.

From the document Nucleic Acids Res., 27:e34, 1999, it is known in the art to polymerize acrylamide to a gel in a solution containing PCR reagents and at a very low concentration DNA. Thereafter the amplification is made. Then result from the immobilized and laterally distributed DNA molecules also immobilized DNA colonies comprising respectively identical DNA.

From the document DE 198 54 946.6-42 is known in the art a method for cloning and for copying genetic or other biological material on surfaces, the substances to be copied being immobilized on a solid body surface, and copying being made by amplification or binding of complementary substances with subsequent transfer and binding to an opposite solid body surface.

In a plurality of documents, DNA chips are described which carry DNA libraries in a tight grid dimension. The preparation is made in most cases by photolithography, the “filling-up” of the grid elements being performed sequentially. Just as examples, reference is made to the documents U.S. Pat. No. 5,744,305, U.S. Pat. No. 5,424,186, U.S. Pat. No. 5,412,087 and U.S. Pat. No. 6,022,963.

It is common to the prior art using dilution sequences that the preparation of the dilution sequences and the handling of the individual dilution fractions is complicated and time-consuming. This drawback grows in an over-proportional manner with the number of dilution fractions.

The prior art using substances immobilized on solid body surfaces has the disadvantage that all reactions take place on surfaces and not in the volume of the solution. Thereby only small reaction rates are achieved, compared to reactions in the solution.

In the above method using a polyacrylamide gel, there is a reaction in the volume, the reaction rates are however nevertheless unsatisfying, since the reactions take place in a diffusion-controlled manner, and the diffusion coefficients are very small (“quasi-immobilization” because of the gel condition).

Finally, it is normally not possible, with the prior art libraries, to prepare copies in a simple way or to make duplicates thereof.

### TECHNICAL OBJECT OF THE INVENTION

The invention is based on the technical object, compared to the prior art, to specify a substance library in the form of a two-dimensionally resolved grid-type arrangement, which can be prepared in an uncomplicated way, in the grid elements of which reactions can take place with very high reaction rates, and which can in an easy way be multiplied.

Basics of the Invention.

For achieving this technical object, the invention teaches that the grid elements are configured as capillary hollow spaces with at least one opening at one end, the capillary axes of the capillary hollow spaces being in parallel to one another and the openings of different capillary hollow spaces being arranged in a grid area. Capillary hollow spaces are hollow spaces wherein upon contact of the opening with an aqueous solution capillary ascension takes place, i.e. the cohesion forces in the aqueous solution are smaller than the adhesion forces of the aqueous solution to the capillary inner surface. In other words, the capillary inner surface is wettable by the aqueous solution and correspondingly equipped with regard to the material surface. A grid element according to the invention thus consists so to speak of a bundle of parallel capillaries at least open at one end. The grid area may be plane or one or two-dimensionally curved. In every case, in the reference system of the grid area, a two-dimensionally resolved association substance/grid element is obtained.

The preparation of such a nucleic acid library is possible in a particularly simple way, namely by means of the method according to the invention for preparing a nucleic acid library in the form of a two-dimensionally resolved grid-type arrangement with a plurality of grid elements, every grid element containing, on the statistical average, a defined number of nucleic acid types having a specific sequence information, and wherein fluids brought into different grid elements do not communicate with one another, comprising the following steps: a) a two-dimensional grid-type arrangement of grid elements configured as hollow spaces comprising openings is generated, b) the openings of the hollow spaces are brought into contact with a solution containing nucleic acids, under co-operation of capillary forces a partial amount of the solution being sucked into every grid element, c) the openings of the hollow spaces are separated from the solution, d) a drying step is performed, e) and as an option the grid-type arrangement as a whole is subjected to an amplification step, the concentration of the nucleic acids in the solution and the dimensioning of the hollow spaces and the openings thereof with regard to the size of the partial amount sucked into a grid element being mutually adjusted such that the partial amount of solution sucked into a grid element contains, on the statistical average, a defined number of nucleic acid molecules, in particular 1. In other words, the grid area is brought into contact with a solution containing different nucleic acids in larger amounts, for instance from a cell preparation or a “one-pot” library. For known nucleic acid total concentration and known height of rise of the solution in the capillary, the sucked-up volume and thus the amount or the number of sucked-up nucleic acid molecules can be calculated by using the capillary cross-section. The dimensions are to be selected, by simple calculations and/or simple tests, such that according to the calculation, on the average a desired number of nucleic acid molecules are taken up. By using the Poisson distribution, this means in the case of an on the statistical average single molecule with a precise reflection that 36.8% of the grid elements do not contain one single nucleic acid molecule, 36.8% of the grid elements contain one single nucleic acid molecule and the remainder contains more than one nucleic acid molecule. A verification is easily possible, if necessary after amplification, by counting the share of the empty grid elements. For the purpose of the invention, for instance the criterion “on the statistical average 1 molecule per grid element” is assumed as fulfilled, if 10% to 90%, preferably 10% to 60%, most preferably 20% to 45% of the grid elements are empty. With an assumption of more than one molecule per grid element, a verification may be performed by that by means of statistics the number of the grid elements is calculated with the desired (defined) number. As belonging to the number defined in an individual case is then regarded the number of grid elements calculated with the statistical distribution with the desired number of molecules +100% and −70%. After the subsequent separation from the solution, the drying step is performed by removing solution from the faces between the openings, for instance by IR drying, but also for instance by swabbing with an hydrophobic swab. If an amplification step is performed, it is recommended to mix the necessary reagents into the solution prior to bringing into contact with the grid area.

As a result, a defined dilution which may in addition be performed with extreme dilution factors, and a filling-up of all grid elements with the dilution fractions is simultaneously achieved in a very simple operating step. The grid elements are not loaded sequentially, in a very time-consuming manner, but rather in parallel. This permits without additional time loss the preparation of libraries of nearly infinitely high populations, the size of which is only limited by the structural design of the grid elements. Further it is an advantage that reactions, e.g. amplifications, transcriptions and/or expression, can always be performed in the solution, thus high reaction rates being secured. Finally PCR may quantitatively be performed, same as LCR.

Further, the invention teaches a method for copying a nucleic acid library according to the invention, wherein all or a part of the grid elements of a grid-type arrangement loaded with nucleic acids and all or a part of the grid elements of an empty grid-type arrangement are connected to one another with their respective openings in a defined mutual orientation with regard to the two-dimensional position resolution, then either a) if necessary a mobilization of the nucleic acids in the loaded grid-type arrangement being performed, b) a reaction solution for an amplification step being brought into the grid elements connected to one another of the two grid-type arrangements, and c) an amplification step being performed, or then a transfer of nucleic acids into connected grid elements of the empty grid-type arrangement being performed by a′) if necessary a mobilization of the nucleic acids in the loaded grid-type arrangement, and b′) a transport of the mobilized nucleic acids from the loaded grid-type arrangement into the empty grid-type arrangement, wherein then the two grid-type arrangements are separated from one another, and as an option prior to or after the separation an immobilization of the nucleic acids in the previously empty grid-type arrangement is performed. It is understood that in case of an exclusive utilization of the capillary forces, the horizontal projection of the height of rise of the reaction solution on a length coordinate of a grid element must be greater than the length of a grid element, in order that the reaction solution can rise into the connected grid element. The height of rise should in so far guarantee a complete filling-up of the two grid elements connected to one another. Of course, the transfer may also take place under application of additional force fields, such as magnetic or electric force fields (under application of correspondingly adapted nucleic acids modified for an interaction with the force fields), but also gravity fields (centrifugation). A library according to the invention can as a result be multiplied or transferred in a simple way, since the transfer or the duplication of the grid element contents takes also place in parallel and not sequentially. In principle, any initial or final concentrations of nucleic acids can be used. A modulation by selection of the stringency conditions is also possible.

Finally the invention also comprises the use of a nucleic acid library according to the invention for preparing a protein or peptide library, into the grid elements of the nucleic acid library an expression matrix being brought under the co-operation of capillary ascension, and the expression reactions being performed. In this manner, protein and peptide libraries can also be prepared in a parallel way. Equally, with previous addition of an assay mix to the expression mix, the production of certain expression products can be detected.

Further applications of the invention are explained in detail below by reference to examples of execution. In all generality, these further applications comprise: cloning and sub-cloning chromosomal nucleic acid fragments, sorting nucleic acid fragments (chromosome walking), automated sequencing, quantitative PCR and RT-PCR, expression analyses, analysis of polymorphisms, design of new aptamers and ribozymes, design of functional proteins, such as highly affinitive proteins (e.g. antibodies) and enzymes, target identification by screening genomic libraries and candidate identification by screening genomic libraries.

The preparation of a solution containing nucleic acids with heterogeneous population may be performed in the most various ways. Examples can for instance be found in the documents Nucl. Acids Res., 17:3645, 1989 (amplification of genomic fragments), Nucl. Acids Res., 18:3203, 1990, and Nucl. Acids Res., 18:6197, 1990 (chemical solid phase synthesis of DNA molecules in automatic synthesizers). Any number of the populations members is in principle possible, it is however recommended to select the number in the order of the number of the grid elements of a grid-type arrangement.

### EMBODIMENTS OF THE INVENTION

In the following, different embodiments of the invention are described in an exemplary manner.

The grid elements may in principle have the most various internal cross sections. For the reason of a simple preparability, it is preferred that the grid elements are configured as capillary hollow spaces of a substantially cylindrical shape.

The ratio of length to width of the capillary hollow spaces is typically in the range from 2 to 500, preferably from 2 to 20, most preferably from 5 to 10. As the width is regarded the largest dimension in a plane orthogonally to the longitudinal axis of the capillary. The width of the capillary hollow spaces is typically in the range from 0.1 μm to 1,000 μm, preferably from 0.1 μm to 100 μm, most preferably from 0.1 μm to 10 μm. Small widths secure on one hand a high density of the grid elements and on the other hand a high height of rise. Width and length may be selected, under consideration of the material of the inner capillary face, such that the height of rise for a capillary oriented orthogonally to the liquid surface, is at least as large as the length. The height of rise may possibly be increased or decreased by addition to the solution of additives affecting the surface tension. Equally by coatings modifying the wetting of the inner capillary face, the height of rise may be affected. A decrease or prevention of a coverage of the edges of the openings can be achieved by addition to the solution of additives modifying (increasing) the viscosity of the solution. Capillary arrangements not orthogonally to the liquid surface are of course also possible. The lateral density of the grid elements is typically in the range from 1/mm² to 10⁸/mm², preferably from 10²/mm² to 10⁸/mm², most preferably from 10⁴/mm² to 10⁸/mm².

It is preferred that the capillary hollow spaces are open at both ends, and the respectively opposite openings form mutually parallel grid areas. In this case, an always complete filling-up of the capillaries is secured, if the height of rise or the force field is sufficient. Further, the method according to the invention for copying can then particularly easily be employed.

The structural material of the grid elements may be selected from the group comprised of “metallic materials, surface-passivated metallic materials, ceramic materials, glasses, polymeric materials and combinations of these materials”. In any case, it has to be secured that the inner face of the grid elements does not show any hydrophobic properties, at least in part. For selecting a material, care has to be taken that the material will not disturb the reactions to be performed. As metallic materials, for instance Cr—Ni steels and gold can be used. A surface-passivated metallic material is aluminum including the usual technical alloys. With regard to ceramic materials, in addition to clay materials, in particular the oxide glass and graphite ceramics are mentioned here. Common to all these groups is a very low porosity. As glasses, all usual laboratory glasses are possible. Suitable polymeric materials are for instance: HDPE, PET, PC and PP. The grid-type arrangement may be further configured such that the faces between the openings are made hydrophobic, for instance by a coating with usual hydrophobation agents on fluorine and/or silicone basis. It is also suitable that the edges of the openings have edge radii being as small as possible. Both factors will contribute to the prevention of a coverage of the edges by the solution and thus cross-contamination between different grid elements.

The grid elements may be surface-modified on the inner sides by anchoring sites, preferably by covalent binding sites, for nucleic acids or proteins or peptides. The immobilization may for instance be made by means of biotin/streptavidin. Then, for instance after an amplification or an expression, washing steps can be used, by means of which reagents are rinsed away from the grid elements.

Preparation Methods of Grid-Type Arrangements.

Grid-type arrangements according to the invention may be prepared in the most various ways.

The first method consists in densely packing commercially available glass capillaries of a given length, the two capillary ends forming with their openings two respectively parallel grid areas. In the same way, commercially available metal capillaries, if necessary provided with an inner coating, may be used. If the length of the commercially available capillaries is larger than desired, a package formed of the capillaries may be cut in a direction orthogonally to the capillary axes, thus capillary plates with grid elements of smaller length being created.

Equally can be used ready-to-use capillary plates, such as micro-channel plates available for instance from Hamamatsu Photonics Deutschland GmbH. These plates have a plurality of identical channels extending orthogonally to the main faces with a channel diameter of down to 10 μm.

Capillary plates may also be prepared by selective etching of glass plates. Another technology for producing micro-channels or capillaries is laser drilling. Thereby, capillaries can be made from nearly any material with very high accuracy with regard to inner diameter and grid-type arrangement.

Capillary plates may also be made by using methods usual in the sector of the semiconductor industry for producing topographies. Here in particular phototechnical methods can be used. Capillaries with extremely small inner diameters and extremely high density can for instance be produced by exposure methods using synchrotron radiation. For details, reference is made to the relevant technical literature about the generation of semiconductor topographies.

Assay Formats.

For detecting grid element contents, reactions and/or interactions of the grid element contents, in principle the most various technical methods may be used. These are for instance: UV scanning, molecular beacons, exonuclease probes, scintillation proximity assay, fluorescence resonance energy transfer, homogeneous time-resolved fluorescence, fluorescence polarization, filter binding assay, mass spectrometry, MALDI-TOF and NMR. It is understood that the respectively used detectors have to be configured for a sufficiently fine position resolution corresponding to the grid-type arrangement. In the case of using glass-materials in connection with optical detection methods, care has to be taken that no crosstalking of the signals of different grid elements is possible, for instance by using opaque glasses. Reading-out may take place in parallel or sequentially. Parallel reading-out may be performed for instance by means of CCD elements with a sufficiently high pixel density or by means of films, if necessary with interposition of suitable optical systems. Sequential reading-out may be performed by subsequent “addressing” of the individual grid elements, for instance by mechanical displacement of detectors and/or if necessary of interposed optical systems. With regard to the various assay formats, reference is made to the relevant technical literature.

At any case, a reliable association of a signal to a specific grid element must be possible. For this purpose it is recommended to arrange reference positions. A very simple possibility is the provision of one or two reference edges mechanically sufficiently precisely machined at one border or two borders of the grid-type arrangement. These reference edges need then only be brought to rest against corresponding stop elements of the respective devices, and with the known geometry of the arrangement of the grid elements, then a reliable association of position coordinates to the grid elements is possible. Of course, the most various other mechanical devices for positioning components are also suitable, for instance independent stop elements and/or positive-linkage elements, also in or at the main faces of the grid-type arrangement. The exact alignment further is elementary not only for the detection, but also for the preparation of copies. Therefor, the master grid-type arrangement and the copy grid-type arrangement have to be precisely aligned with regard to each other.

Reference positions may however also be non-mechanical. It is for instance possible to arrange in the plane of a grid area at defined positions one or two or more signaling elements which are detected by means of a detector in a position-resolved manner. With the detecting signaling elements, then the overall position of the grid-type arrangement and thus of individual grid elements is known. Signaling elements may be provided in a grid element, but however also between grid elements. It is recommendable to select the signaling elements such that the signals emitted by them are measured with the same detector as for the measurement of measuring signals at the grid elements. Binding of substances to grid element inner faces.

Under certain circumstances it may be recommendable to anchor or immobilize the nucleic acids, proteins or peptides on the grid element inner face. This is in particular necessary, if washing steps are to be interposed. For this typically the inner face is modified with regard to its surface. All usual technical methods are suitable.

In the following, further embodiments of the invention, in particular also the uses thereof, are described in more detail based on figures. There are:

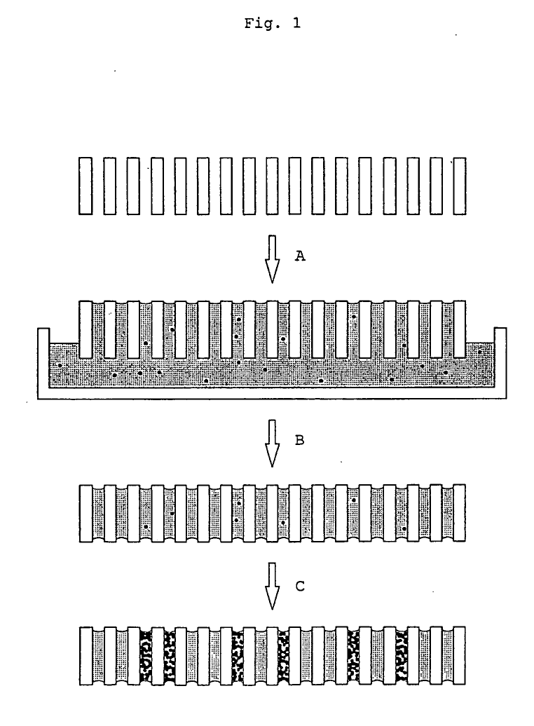

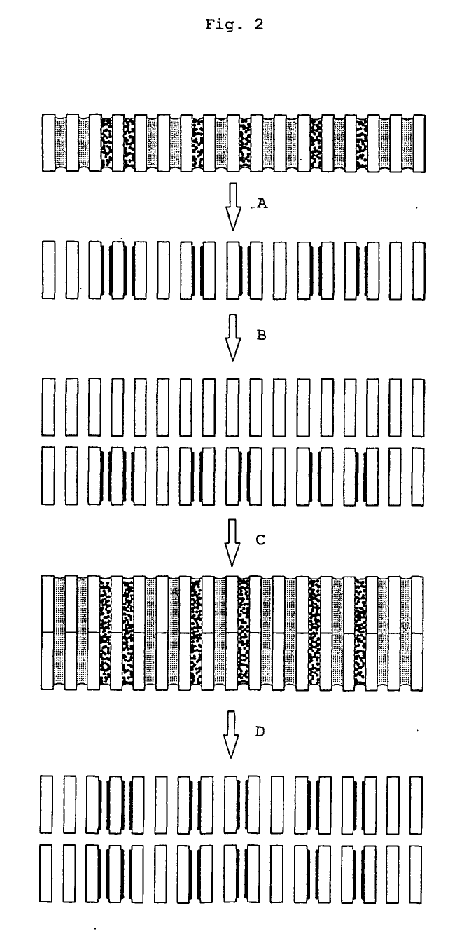

FIG. 1 the preparation of a nucleic acid library;

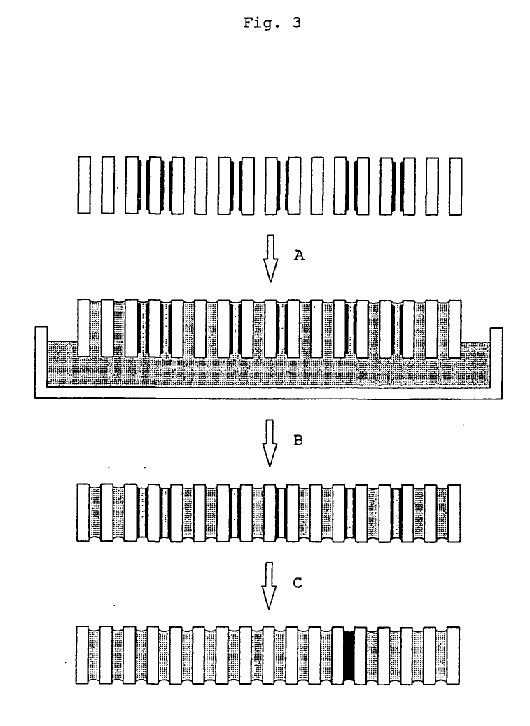

FIG. 2 copies of a nucleic acid library;

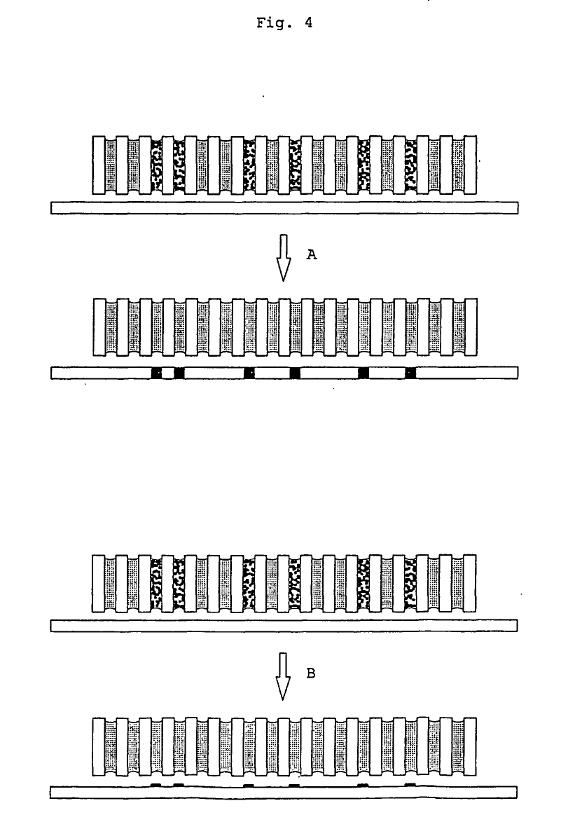

FIG. 3 the expression of a nucleic acid library;

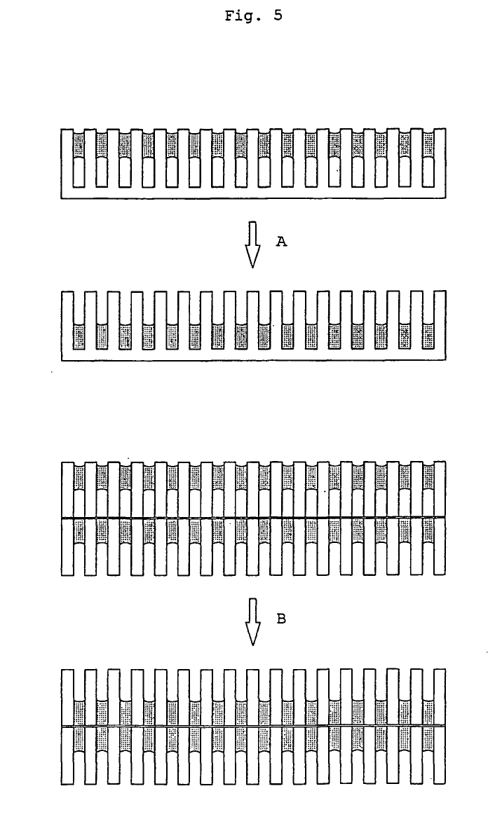

FIG. 4 a transfer or copy of a nucleic acid library on an areal porous or non-porous support;

FIG. 5 a method for completely filling-up grid-type arrangements closed on one side;

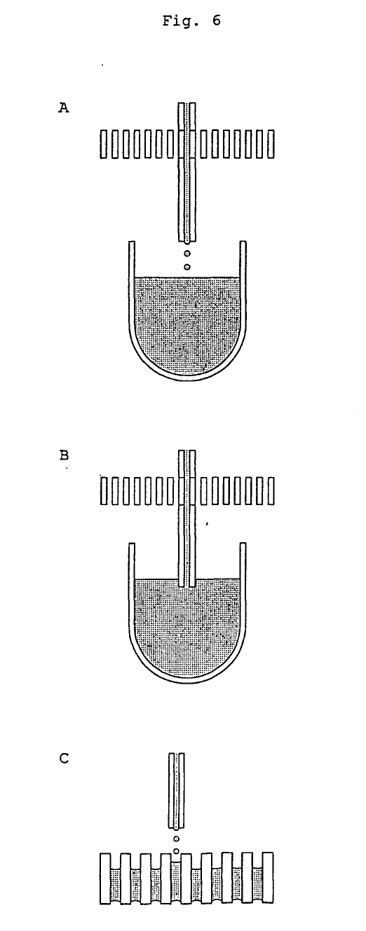

FIG. 6 a method for processing individual grid elements;

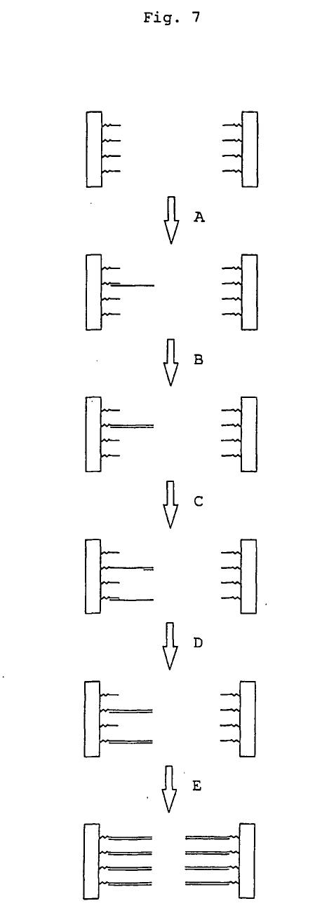

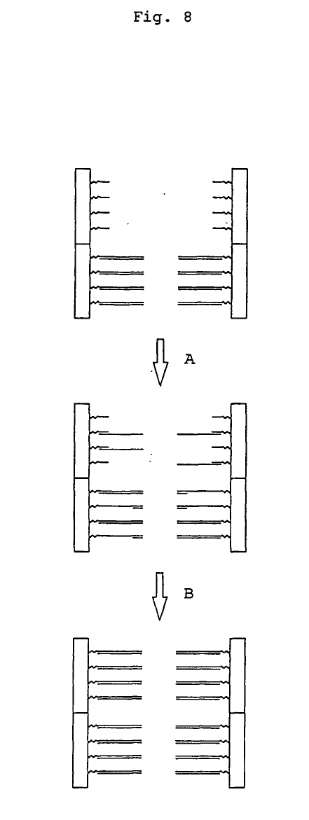

FIG. 7 a method for cloning nucleic acids with immobilized primers;

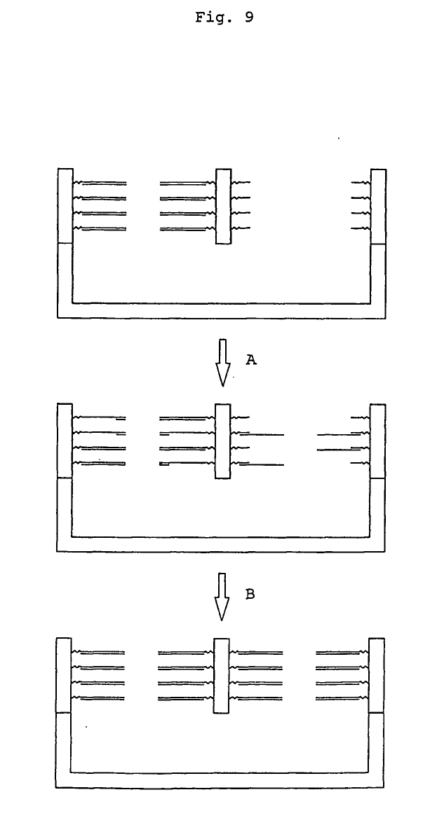

FIG. 8 a method for vertically copying a nucleic acid library with immobilized primers;

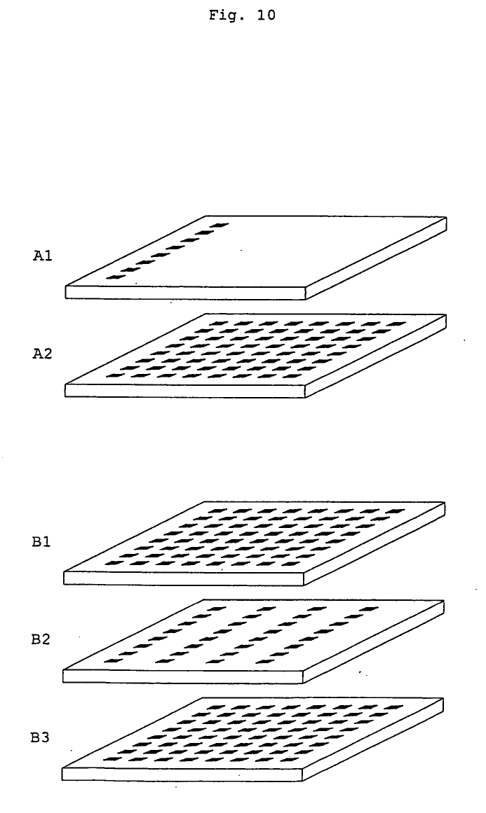

FIG. 9 a method for horizontally copying a nucleic acid library;

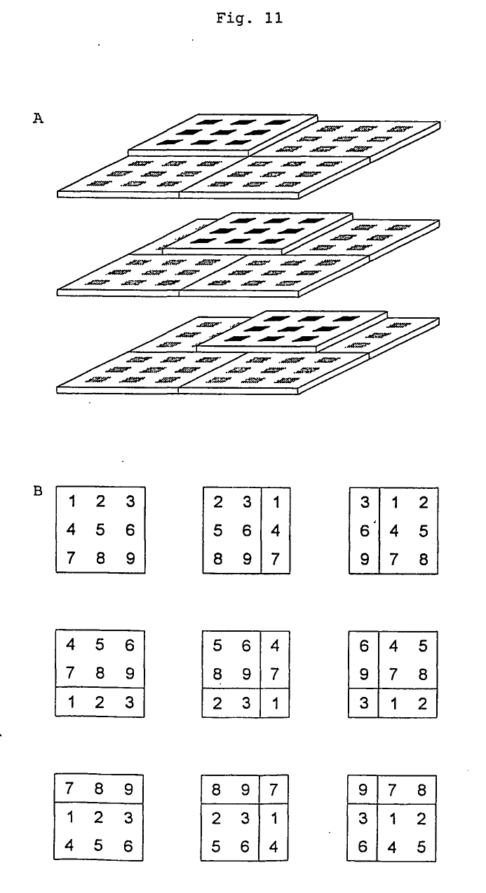

FIG. 10 a method for processing a partial amount of the grid elements of a grid-type arrangement;

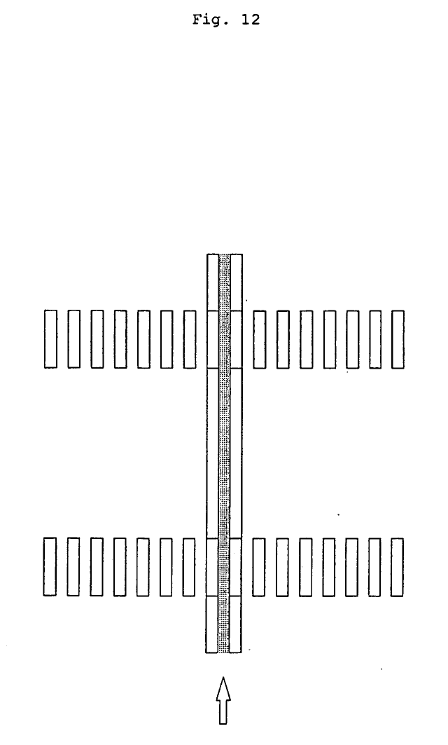

FIG. 11 a use of the method for copying for preparing libraries with permutated order of the grid element contents;

FIG. 12 a method for ordering grid element contents;

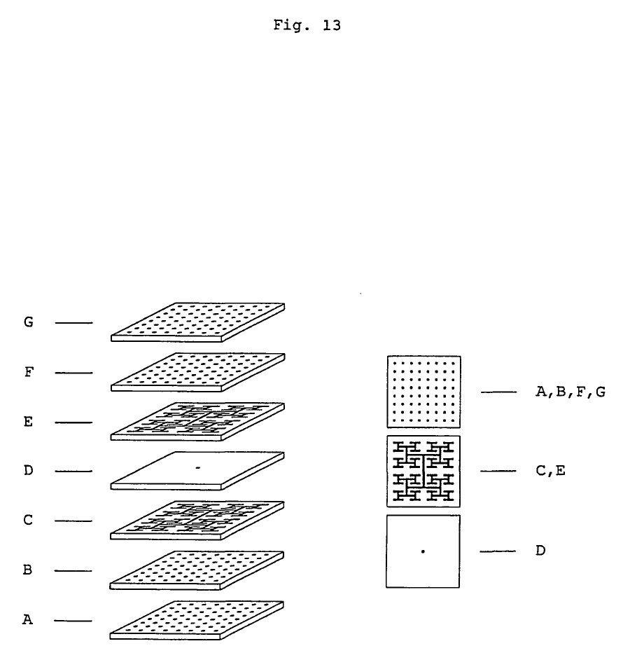

FIG. 13 an alternative method for ordering grid element contents;

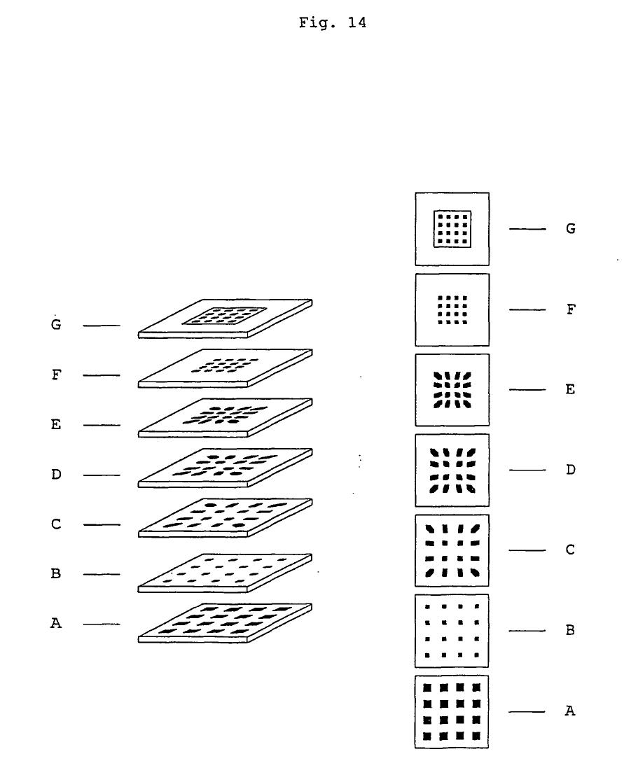

FIG. 14 a method for reducing libraries in the course of a copying process;

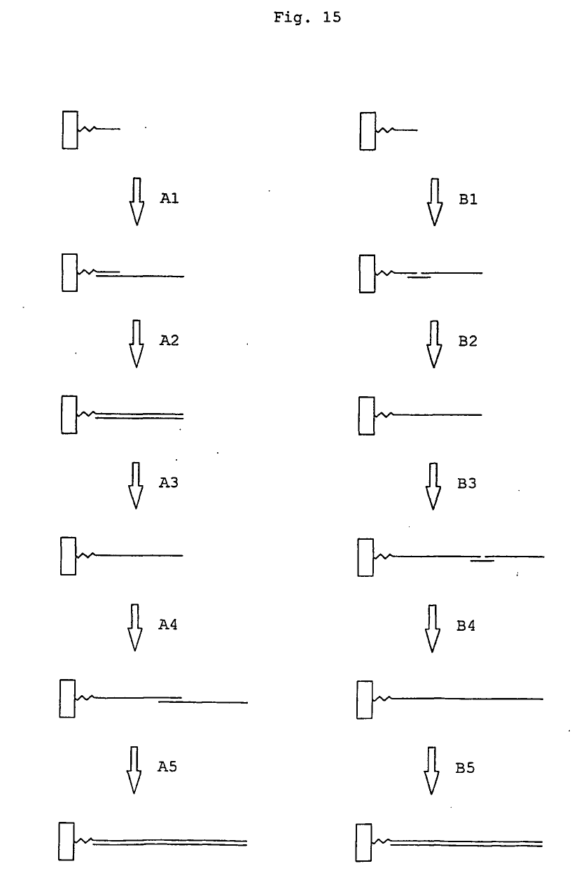

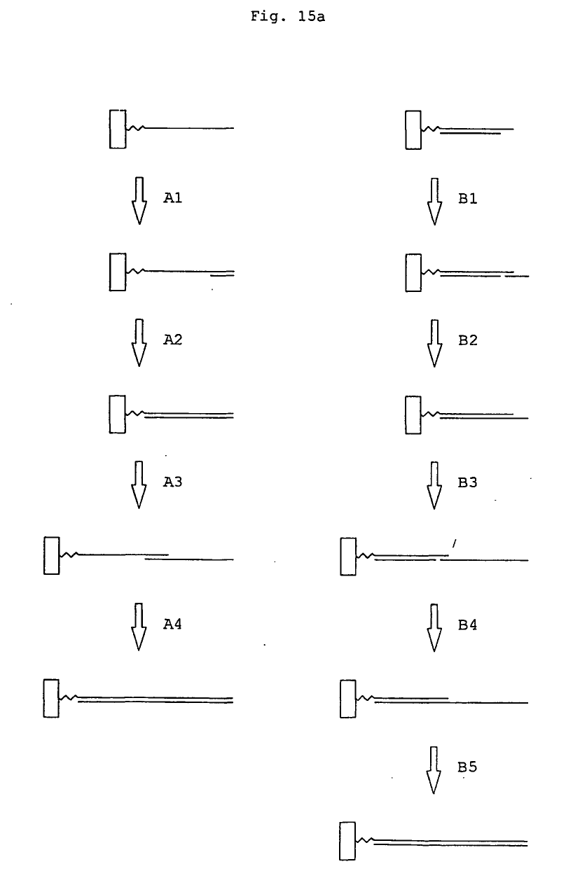

FIG. 15 a method for processing nucleic acid libraries with extension of the nucleic acids in the grid elements;

FIG. 15a a method for extending nucleic acids in different grid elements;

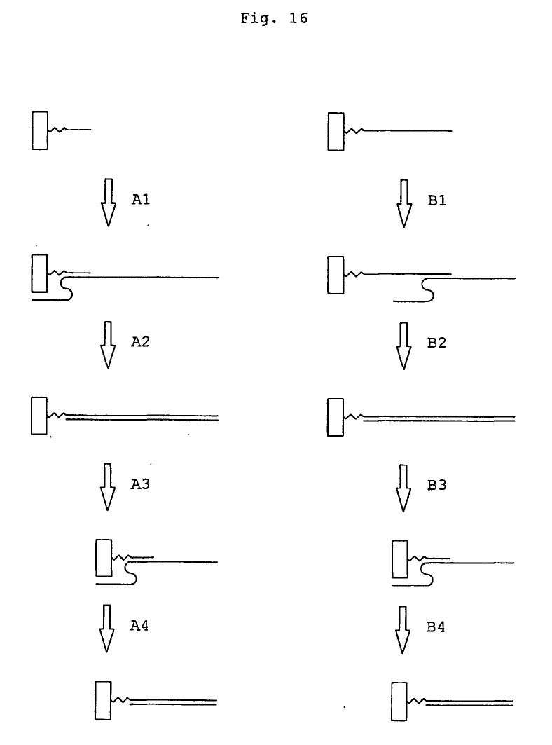

FIG. 16 a method for shortening and recombining nucleic acids;

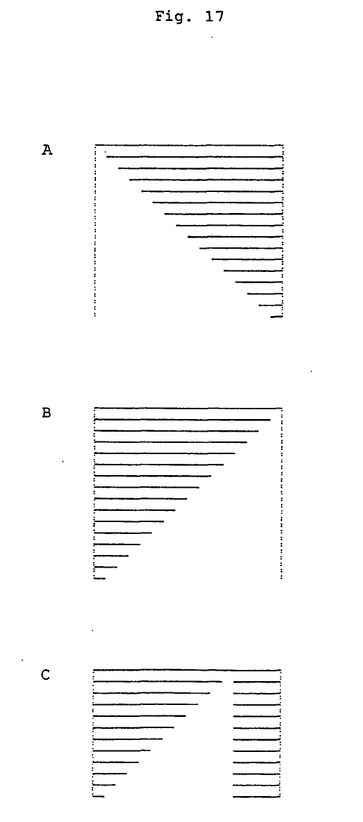

FIG. 17 a representation of different deletion mutants, obtainable by methods according to FIGS. 15, 15a or 16;

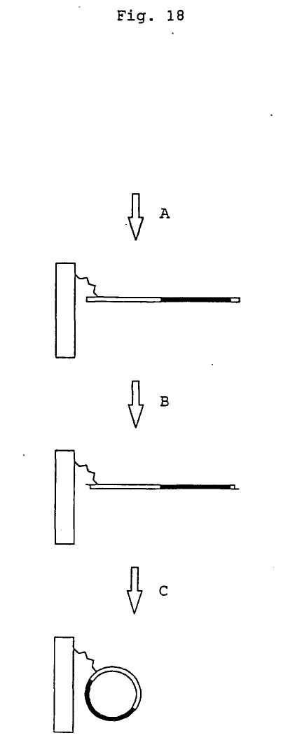

FIG. 18 a method for in-situ recombining genetic elements;

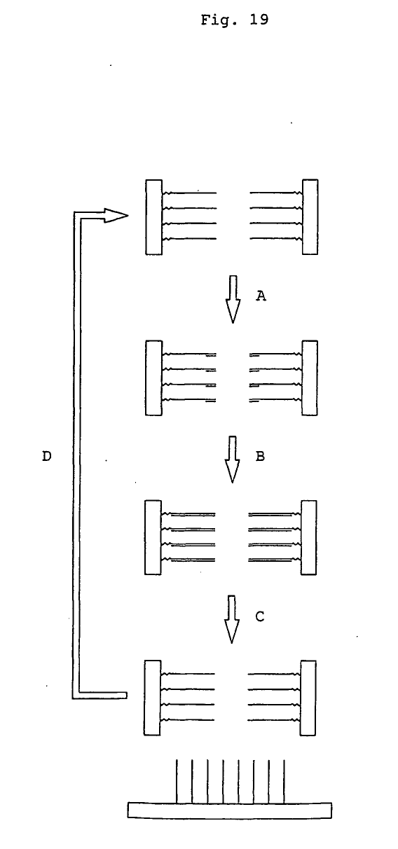

FIG. 19 a method for preparing a gene chip;

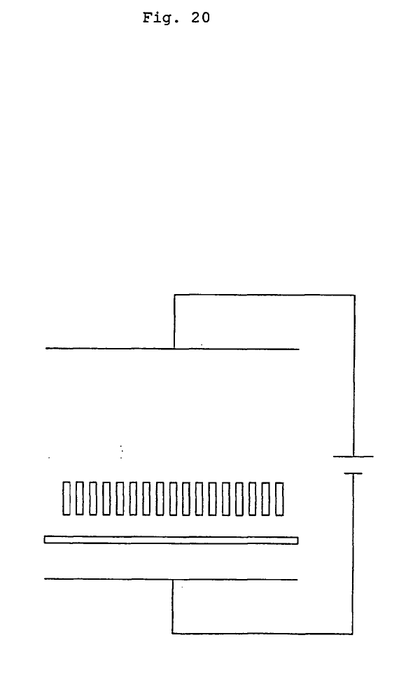

FIG. 20 a method according to FIG. 19 with the additional application of an electric force field;

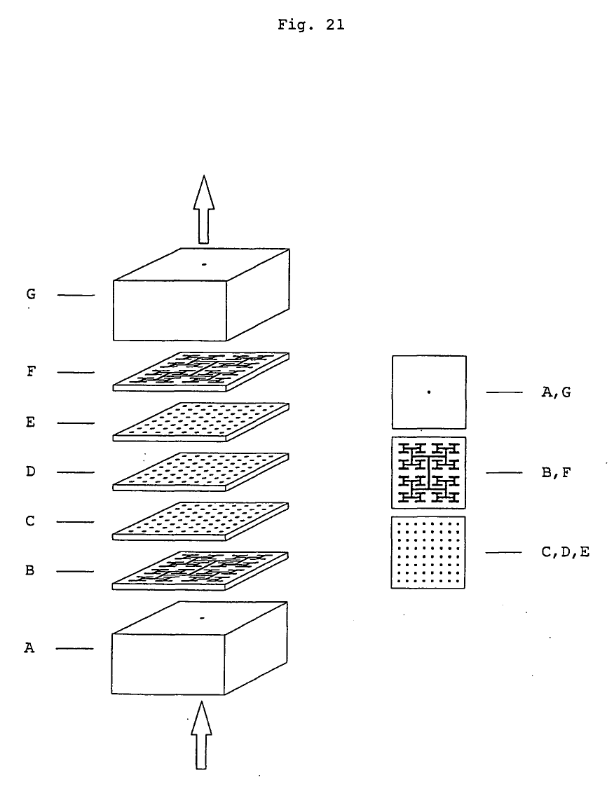

FIG. 21 a device for a parallel flow through one or more grid-type arrangements;

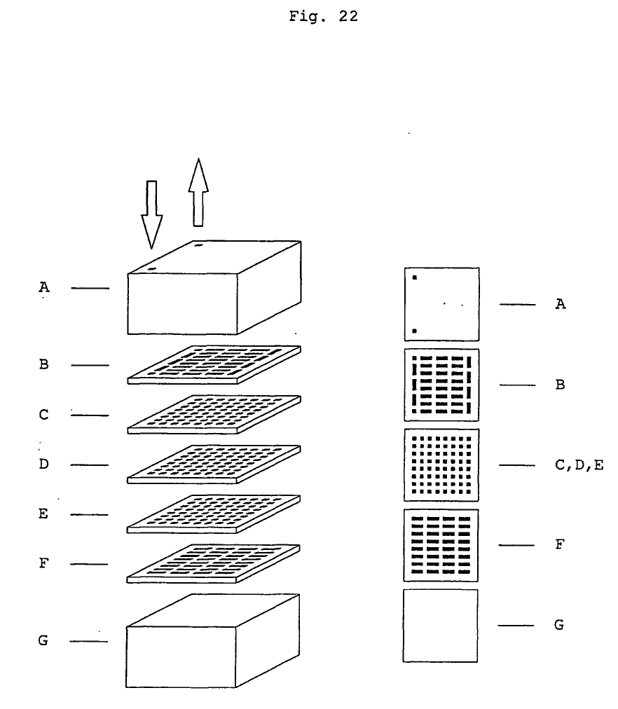

FIG. 22 a device for a sequential flow through one or more grid-type arrangements;

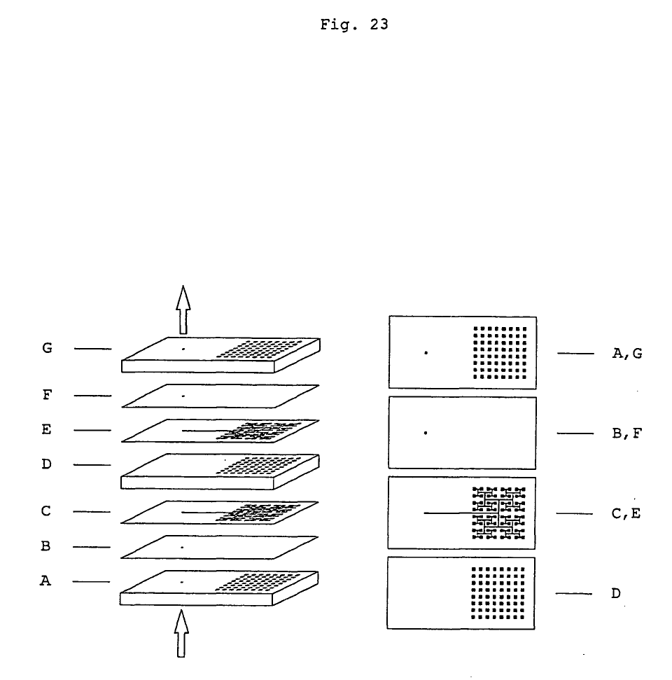

FIG. 23 a subject matter according to FIG. 21 in an embodiment with real-time measurement in the grid elements;

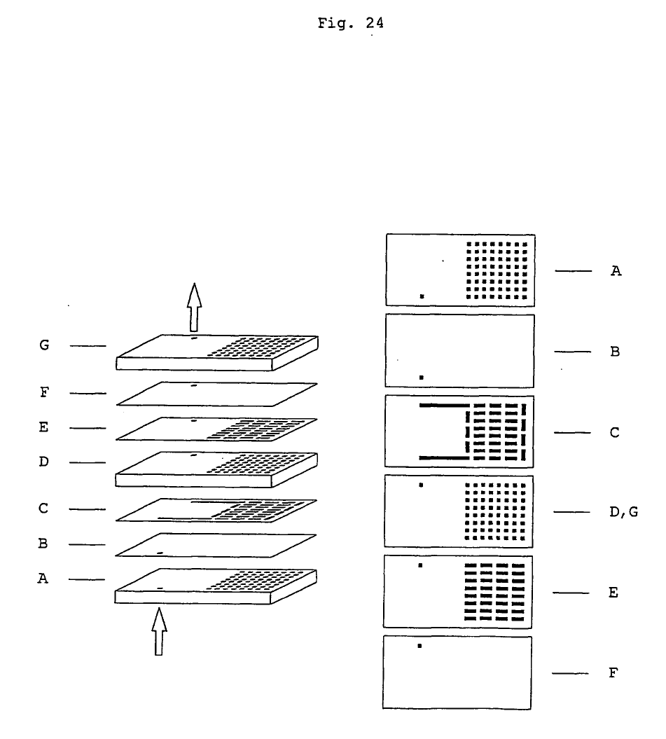

FIG. 24 a subject matter according to FIG. 22 in an embodiment with real-time measurement in the grid elements; and

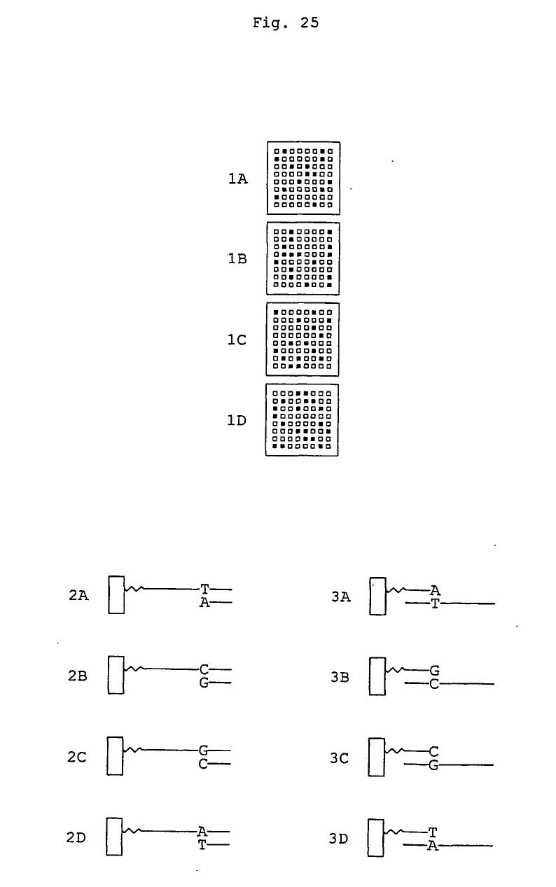

FIG. 25 a method for parallely sequentiating nucleic acids, proteins or peptides.

In FIG. 1 is shown the preparation of a nucleic acid library. Firstly, a chemical synthesis of a DNA library with for instance 60 randomized positions takes place. Then follows a dilution of the library and the loading of the grid-type arrangement. In the embodiment, only the capillary force is sued. After filling up, a partial deep-freeze drying takes place. An increase of the nucleic acid concentrations in the grid elements is performed by means of PCR in the presence of ethidium bromide. The identification of the grid elements is achieved with amplificates by fluorescence microscopy (excitation at 300 nm and measurement at 600 nm). The removal of the cloned amplificates takes place by a micro-capillary and transfer into standard PCR approaches. The analysis of the amplificates is performed by standard didesoxy sequentiation. With the result thereof, a comparison with the sequentiation of the original library (passing-through bands in all four sequentiation tracks). Finally, an introduction of immobilized primers takes place.

FIG. 2 shows the copying of a nucleic acid library. Firstly, a master grid-type arrangement according to FIG. 1 is prepared by PCR without ethidium bromide. Then follows a complete vacuum drying. To the master so obtained is made an addition of a second grid-type arrangement under alignment of two reference edges. Then again a PCR and a complete vacuum drying are performed. After addition of an ethidium bromide containing solution to both grid-type arrangements, a partial deep-freeze drying is performed. The analysis of the grid elements takes place by fluorescence microscopy (excitation at 300 nm and measurement at 600 nm). The removal of the cloned amplificates is performed by means of micro-capillaries. Subsequently these are transferred into PCR approaches. The analysis of the amplificates takes place by standard didesoxy sequentiation. The amplificates in the master and the copy grid-type arrangement are compared to each other.

In FIG. 3 is shown the expression of a nucleic acid library. Firstly, a preparation of a grid-type arrangement according to FIG. 1 takes place, with a DNA fragment coding for a single-chain antibody. Then a preparation of copies of the grid-type arrangement according to FIG. 2 is performed, followed by a complete vacuum-drying. The DNA containing grid elements are identified in the master grid-type arrangement by ethidium bromide coloration. To a copy grid-type arrangement is added an expression mix with H marked lysine. After filtration of the grid-type arrangement by a PVDF membrane, washing and drying of the membrane follows, as well as an autoradiography. The detection of the expression takes place by comparison of master and copy grid-type arrangement (identical patterns for DNA and protein).

FIG. 4 describes a method for transferring nucleic acids, proteins or peptides on (A) a porous surface (membrane) or (B) a non-porous surface. The surfaces may consist of metalloid or metallic materials, ceramic materials, glasses, polymeric materials or combinations of these materials. The transfer may take place by an electric field, magnetic interaction or centrifugation. In porous surfaces, the transfer may also be achieved by over or under-pressure (filtration). For making the transfer of small nucleic acids, proteins or peptides by centrifugation or filtration easier, micro or nano-beads may be used (for instance proteins with N-terminal biotin in the expression system according to FIG. 3 can be synthesized, said proteins binding to added streptavidin nano-beads).

FIG. 5 shows a method for completely filling-up grid-type arrangements closed on one side, (A): after application of the liquid the capillary arrangement can be accelerated in the centrifugal field, until the liquid arrives at the bottom of the closed grid elements. (B): For two capillary arrangements separated by dialysis membranes firstly a first side is filled up by centrifugation, as described under (A). The second side of the capillary arrangement is filled up in a second centrifugation step up to the membrane. An escape of the liquid from the elements of the first side can be prevented by closing the first side. Preferably, two different grid-type arrangements are selected. The adhesion of the liquid in the grid elements of the first side is larger than that of the second side (smaller capillary diameter or material with higher adhesion). The drainage of the capillary arrangement already filled up is achieved by selection of suitable rotation speeds for the centrifugation. The dialysis membrane serves for instance for the addition or separation of low-molecular components during the expression of grid elements.

FIG. 6 shows a method for processing individual grid elements. (A): Nucleic acids, proteins or peptides are transferred from individual grid elements by application of capillaries and passage of liquids or gases (aerosol generation) into a test tube. For conditionally immobilized molecules the passing medium includes components for the mobilization (e.g. free biotin for streptavidin-biotin immobilized molecules). Double-stranded nucleic acids with an immobilized strand are a special case of the conditional immobilization. Here the mobilization of the not immobilized strand is preferably achieved by a passage of hot or alkalic liquids or gases or by electro-magnetic field influencing. Drawing-off of very small liquid volumes into the test tube can be achieved by the methods known in the state of the art for the separation of small liquid amounts (for instance piezo tubes, piezoplanar edge or side shooters, piezo lamina or shearing transducers, bubble-jet edge or side shooters). With repeated processing of the grid elements, the applied capillary parts are purified before every step (e.g. by heating or aggressive chemicals). The purifying step is particularly important when processing amplifiable nucleic acids. (B): The application of capillaries may be employed for sucking-in liquids or aerosols. This step also serves for the individual loading of grid elements with primers (e.g. introduction of biotinylated primers in a grid-type arrangement comprising covalently bound streptavidin). (C): Further a grid-type arrangement closed at the bottom or filled-up with liquid may be loaded by the methods known in the state of the art for the separation of small liquid amounts (see above). The loading process is preferably performed in a saturated atmosphere. The method may be repeated as often as desired and is suited for the introduction of additional nucleic acids, proteins, peptides, and other molecules for testing for binding or catalytic activity. The method is further suited to adjust various crystallization conditions of nucleic acids, proteins and peptides in a capillary arrangement. Successful crystallization conditions of micro-crystals can be identified by standard methods (e.g. light microscopy with polarization filters or light scattering). The crystallization conditions can be adjusted in an analogous manner to the conventional methods as e.g. according to the batch method, the vapor diffusion method or the dialysis method (cf. Ducruix and Giege, in: Crystallization of Nucleic Acids and Proteins, IRL Press, 1992). The micro-crystals may be used as germs for standard crystallizations (e.g. according to the hanging-drop, sitting-drop, sandwich-drop or dialysis method) in the X-ray structural analysis.

FIG. 7 shows a preferred use of the a method for cloning nucleic acids with immobilized primers. The method may for instance be used for cloning genomic fragments such as DNA, cDNA or RNA. Further, the method may be used for synthetic nucleic acid libraries, such as for example for the selection of aptamers or spiegelmers and for the selection of proteins by phage display or ribosome display. A first primer is bound to the capillary inner walls of the grid-type arrangement (either at the 5′ end or at any other positions—only the 3′ OH group must be free for step C). For this purpose, the grid elements are simultaneously occupied with one or a few primers according to the steps described in FIG. 1 (e.g. by binding a biotinylated primer to capillary arrangement coated with streptavidin). The grid elements may be occupied in an individually different manner according to the step described in FIG. 5 (e.g. biotinylated primers with an individual sequence). (A): The primer binds complementary fragments from a solution of nucleic acids. (B): The primer is extended at its 31 end by polymerases. (C): The complementary fragment is released. A free primer is taken up at the 31 end of the extended nucleic acid (the second primer may also be present in an immobilized manner, corresponding to the bridge technology—U.S. Pat. No. 5,641,658). The released fragment is taken up by a free, bound primer. (D): The primers are extended at their 3′ end by polymerases. (E): The method is then repeated as often as desired, preferably by cyclically heating or denaturating the nucleic acids by electromagnetic field action.

FIG. 8 describes a preferred use of the method for vertically copying a nucleic acid library with immobilized primers. (A): The release of single strands takes place, as shown in FIG. 6, by heat denaturation or electro-magnetic interaction. The released single strands may be taken up by immobilized primers in a second (or several) grid-type arrangement(s) aligned with the master. To the immobilized single strands in the master grid-type arrangement, added primers may bind. (B): The primers are extended at their 3′ end by polymerases. The method is then repeated as often as desired. The transfer of released single strands from the master into the copy grid-type arrangements may also take place in an oriented manner, e.g. when liquids or gases pass through the grid-type arrangements or when an electric field is applied. Further, the transfer can be decoupled from the amplification. The nucleic acids in the copy grid-type arrangements can then individually be amplified. This decoupling step may be used e.g. for the integration of differently modified nucleotides in the respective copy grid-type arrangements. A grid-type arrangement converted according to step (B) by denaturation into a single-stranded library can be used for hybridizations with complementary nucleic acids, for instance for chromosome walking or for the association and quantification of DNAs, cDNAs or RNAs. The single-stranded or double-stranded grid-type arrangement can be used for the detection of the sequence-specific interaction with molecules (e.g. gene regulatory proteins, activator proteins, repressor proteins or low-molecular drugs). The DNA molecules can also be modified for the test for interaction (e.g. by methylation or binding of structural proteins such as histones). Further, single-stranded or double-stranded grid-type arrangements originating from synthetic nucleic acid libraries can serve for the identification of new aptamers, spiegelmers and ribozymes. The loading of the capillary inner walls with primers determines in this method configuration under optimum polymerization conditions the final loading of the copied nucleic acid library. A modulation of the loading is important, in order e.g. to optimize hybridization or binding experiments of nucleic acids, proteins or peptides among each other or to each other or to other molecules. By an iterative reduction of the primer concentrations and thus of the nucleic acid or protein concentration, unspecific binding signals are suppressed. Further, e.g. a modulation of the loading is necessary for the design of nucleic acids or proteins with improved catalytic properties. In the copying method, the nucleic acid strands being free in the respective master grid-type arrangement can be immobilized. By addition of both primers in a free form, non-immobilized copies of the nucleic acid strand immobilized in the master grid-type arrangement are generated. These free copies can be used as a matrix for the synthesis of the immobilized counter-strand. This step is employed in order to prepare complementary copy grid-type arrangements. Further, both strands can also be immobilized in the copy grid-type arrangement. For a high loading density of the primers, bridge molecules are generated, corresponding to U.S. Pat. No. 5,641,658. In an analogous manner (no figure), conditionally immobilized proteins can also be transferred. Thus, from a master grid-type arrangement via e.g. His-tag bound, biotinylated proteins can be mobilized by addition of nickel ions. The now mobile proteins can be transferred to a second grid-type arrangement, for instance coated with streptavidin, where they are now immobilized by biotin-streptavidin interaction.

FIG. 9 shows a preferred use of the method for preparing horizontal copies. By this approach, copies of grid elements can be prepared in the same grid-type arrangement.

FIG. 10 shows a use of the method wherein partial regions of the grid-type arrangement are not processed. Only a part of the grid elements of the loaded grid-type arrangement are connected with a part of the grid elements of the empty grid-type arrangement by interposition of a grid mask between the two grid-type arrangements, the number of grid passage openings of the grid mask being smaller than the number of the grid elements of the loaded grid-type arrangement. (A): By controlling or covering grid regions by arbitrarily shaped cover masks (e.g. A1), grid-type arrangements (A2) can be prepared, which contain different nucleic acids, proteins or peptides in partial regions (grid fields) only. In the shown example, the grid elements of one row only are occupied. In an analogous manner, further grid elements can be occupied. This method can for instance be used for the quantitative PCR or LCR. The immobilization of different primers in grid fields permits, in conjunction with the method described in FIG. 7, the simultaneous cloning of several mRNAs or cDNAs in a grid-type arrangement. After for instance coloration with ethidium bromide, the number of clones in the various grid fields can simultaneously be determined by CCD methods known in the state of the art, and can be compared to each other by computer programs. When using one or more reference fields in an analogous manner to the competitive PCR (cf. Halford, Nature Biotechnology 17, 835 (1999)), the dilution fault for the quantification of the gene expression can be eliminated. Further, a grid field according to the step may also be occupied by more than one primer. Thereby a higher loading of the grid-type arrangement can be achieved. This approach requires however that the various clones of a grid field are differentiated by the methods of the state of the art, such as for instance molecular beacons or TaqMan probes. (B): Cover masks (B1) can also be used for the method for copying according to the invention in FIG. 2 or FIG. 8, such that parts only of a master grid-type arrangement are transferred. In the shown example of the cover mask (B2), only the grid elements of the first, third, fifth and seventh column are transferred from the master grid-type arrangement (B3) to the copy grid-type arrangement (B1). The not occupied grid elements of the copy can be occupied in a second or further copying process. For instance in a parallel process, by a lateral displacement of the master by one column towards right, a second copy of each grid element comes into direct neighborhood to the first copy (or, according to the method described in the legend of FIG. 8, the respective counter-strand). This step is important, for instance in order to be able to perform double or multiple determinations on a matrix (e.g. in the quantitative PCR and LCR or expression studies).

FIG. 11 shows a use of the method for copying for the permutation of the grid elements. Firstly, a plurality of identical grid-type arrangements loaded with nucleic acids and having an identical lateral grid dimension of the grid elements are prepared, these grid-type arrangements being arranged side by side, preferably such that the grid dimension of the grid-type arrangements after arranging them side by side is continuously growing over connection regions of adjacent grid-type arrangements. One, several or all grid elements of an empty grid-type arrangement with a preferably identical grid dimension are connected with corresponding grid elements of the nucleic acid-loaded grid-type arrangements arranged side by side. In detail, the following can be performed. (A): Firstly, identical copies are made of the master grid-type arrangement. On four adjacent copies, arbitrary permutations of the master grid-type arrangement can be achieved by staggered application of the copy grid-type arrangements. (B): For clarification, a matrix with nine elements is shown in the possible copies. By bringing a grid-type arrangement into contact with all possible permutations thereof or of another grid-type arrangement, the interactions of nucleic acids, proteins or peptides can easily be determined in a quick and comprehensive way. For instance the grid-type arrangement of human cDNA library can be permutated according to this step. The master grid-type arrangement completed to a double strand under e.g. radioactive or fluorescent marking can be brought into contact with the permutated copies in a single-stranded form (or vice versa). Further, the protein copies can be prepared from the permutated copies in a double-stranded form according to the step described in FIG. 3. The master grid-type arrangement is expressed under integration of radioactive amino acids. After bringing a grid-type arrangement comprising immobilized ligands (nucleic acids, proteins, peptides or any other molecules) into contact with a complete set of permutated copies of nucleic acids, proteins or peptides, thus the interaction of all grid elements can simultaneously be determined.

FIG. 12 shows a method for ordering grid elements. A single connection, for instance by a capillary, between a grid element of the loaded grid-type arrangement and a grid element of the empty grid-type arrangement is prepared, by subsequent defined lateral displacement of the single connection and/or of one and/or both grid-type arrangements, the grid elements of the empty grid-type arrangement being successively loaded with nucleic acids from the grid elements of the loaded grid-type arrangement. The nucleic acids, proteins or peptides in the master grid-type arrangement are conditionally immobilized. Single grid elements of the master grid-type arrangement are passed by a capillary supply of a liquid or gas, and the conditional immobilization is terminated. The molecules of a master grid element are transferred to the copy grid-type arrangement, where they are again immobilized. Single strands being hybridized on immobilized counter-strands can for instance be mobilized upon passage of a hot liquid. The liquid is cooled down when it flows through a capillary arranged between the grid-type arrangements. After arrival at the copy grid-type arrangement, the single strands can bind to complementary primers. Ordering of the grid elements is achieved by lateral displacement of the master grid-type arrangement and/or of the copy grid-type arrangement.

FIG. 13 describes a method for ordering grid elements, as described in FIG. 12, but without lateral displacement of the master grid-type arrangement (A) or of the copy grid-type arrangement (G). Between the loaded grid-type arrangement and the empty grid-type arrangement are interposed the following components: as an option a cover mask (B), a distributor mask (C), preferably with an equidistant distribution path arrangement with regard to a removal point and in a plane in parallel to the grid area, a point mask (D) with a single passage opening, a distributor mask (E), preferably with an equidistant distribution path arrangement with regard to a removal point and in a plane in parallel to the grid area, and as an option a cover mask (F), the removal points of the distributor masks being connected with the passage opening of the point mask, a transfer of the nucleic acids of a grid element of the loaded grid-type arrangement to a grid element of the empty grid-type arrangement being achieved by that the selected grid element of the loaded grid-type arrangement is subjected to a fluid flow and that simultaneously the selected grid element of the empty grid-type arrangement is switched-over so that the fluid flow can pass through, and wherein if necessary the steps of providing the fluid flow and switching-over to passing-through are repeated for desired different grid elements of the two grid-type arrangements. The cover masks (B) and (F) prevent a contamination of the surfaces of (A) and (G). The arrangement of the guide masks (C), (D) and (E) shown as an example secures an equidistant connection of all grid elements of the master (A) and copy (G). The movement of electrically charged nucleic acids, proteins or peptides in the arrangement is preferably performed by microelectrode single-control of the grid elements.

FIG. 14 shows a use of masks for the transfer or copying process, wherein an arbitrary reduction or enlargement of the master grid-type arrangement is achieved. The grid-type arrangement loaded with nucleic acids and the empty grid-type arrangement have a different grid dimension. The connection of the grid elements takes place under interposition of at least one reduction mask or enlargement mask. The device shown as an example of execution has boreholes vertically to the grid area. A reduction or enlargement can also be achieved by an oblique orientation of the grid elements.

FIG. 15 shows the uses of the method for extending nucleic acids in a grid element. The nucleic acids can be extended by the application of complementary fragments in an oriented form by e.g. (A) extension of primers or (B) ligation. (A1): The immobilized primer binds complementary fragments from a solution of nucleic acids. (A2): The primer is extended at its 3′ end by polymerases. (A3): The complementary fragment is released. (A4): A new fragment is taken up at the 3′ end of the extended nucleic acid. (A5): The primers are extended at their 3′ end by polymerases. The method is then continued as often as desired. Preferably the nucleic acids are denaturated by cyclic heating or by electric field action. (B1): The immobilized fragment binds complementary fragments from a solution of nucleic acids. The immobilized fragment is extended by ligation. (B2): The complementary fragment is released. (B3): A new complementary fragment is taken up at the 3′ end of the extended nucleic acid. (B4): The complementary fragment is released. (B5): The steps B3 and B4 are then continued as often as desired. After taking-up a terminal primer and extension by polymerases, the single-stranded product can be completed to a double strand. Furthermore, the methods known in the state of the art for processing nucleic acids, such as fission or decomposition with nucleases, ligation of fragments with smooth or cohesive ends can be combined as desired with the method according to the invention. The nucleic acids used in the hybridization steps are normally completely complementary. The nucleic acids may however contain regions with faulty pairs for the generation of regional or point mutations. These steps for the extension of nucleic acids can be combined as desired with the method described in FIG. 8 or FIG. 9 for vertically or horizontally copying, and be used for building-up complex genomes. The method permits the parallel extension of all grid elements of a grid-type arrangement. For instance a grid-type arrangement of genes can be functionalized for the expression by adding a promoter sequence. Further, for the extension of nucleic acids, grid-type arrangements can be used which contain different fragments in the grid elements. The sequences of the fragments may be known or unknown (random). The method thus permits the preparation of sorted nucleic acid or protein/peptide libraries serving for the quick identification of functional variants (e.g. ribozymes, binding proteins or enzymes). For instance a grid-type arrangement may contain the 5′ terminal sequence of a single-chain antibody gene up to the variable region. For the extension, a grid-type arrangement with sorted fragments containing the variable region is used. In the third step, the grid elements are extended with the 3′ terminal sequence of the antibody gene. After expression of the antibodies, functional variants can be identified for instance by binding to a marked antigen.

FIG. 15a shows uses of the method for extending nucleic acids in different grid elements. By transfer of a nucleic acid from a master grid-type arrangement into an extension grid element, a non-immobilized nucleic acid can also sequentially be extended. The nucleic acids can be extended for instance by (A) extension of primers or (B) ligation. (A1): The immobilized fragment binds complementary primers from a solution of nucleic acids. (A2): The primer is extended at its 3′ end by polymerases. (A3): The extended primer is released and modified by a vertical or horizontal transfer into a new grid element. The new grid element has a sequence being complementary to the 3′ end of the extended primer. (A4): The extended primer is again extended at its 3′ end. The method is then continued as often as desired. Preferably the nucleic acids are denaturated by heating or electro-magnetic field action or alternating field action. (B1): The immobilized fragment binds complementary fragments from a solution of nucleic acids. (B2): The complementary fragments are linked by ligation. (B3): The ligated fragment is then released and modified by a vertical or horizontal transfer into a new grid element. The new grid element has a sequence being complementary to the 3′ or 5′ end of the ligated fragment. (B4): The ligated fragment is then ligated with an adjacent fragment. (B5): The steps B3 and B4 are then continued as often as desired. By extension with polymerases, the product can be completed to a full double strand. In a preferred embodiment, the nucleic acids according to these steps are extended with the device described in FIG. 22 or FIG. 24.

FIG. 16 shows uses of the method for shortening and recombining nucleic acids. The nucleic acids can according to the steps be (A) shortened or (B) shortened and recombined. (A1): The immobilized primer binds within a complementary fragment. (A2): The primer is extended at its 3′ end by polymerases. The complementary fragment is released. A primer being complementary to the 3′ end of the extended primer is taken up and extended at its 3′ end by polymerases. (A3): The extended primer is released and modified by a vertical or horizontal transfer into a new grid element. The new grid element contains a primer binding within the extended primer. (A4): The primer is extended at its 3′ end by polymerases. The steps A3 and A4 are then continued as often as desired. In another embodiment, the fragments hybridizing in step A1 and A3 have identical lengths and sequences. Thereby, for instance in a device according to FIG. 22 or FIG. 24, a set of successive deletion mutants can be produced in one grid-type arrangement only. (B1): An immobilized fragment binds with a sequence section at the 3′ end within a complementary fragment. (B2): The immobilized fragment is extended at its 3′ end by polymerases. The complementary fragment is released. A primer being complementary to the 3′ end of the extended primer is taken up and extended at its 3′ end by polymerases. (B3): The extended primer is released and modified by a vertical or horizontal transfer into a new grid element. The new grid element contains an immobilized fragment binding within the extended primer. The immobilized fragment is extended at its 3′ end by polymerases. The complementary fragment is released. A primer being complementary to the 3′ end of the extended primer is taken up and extended at its 3′ end by polymerases. (B4): The primer is extended at its 3′ end by polymerases. The steps A3 and A4 are then continued as often as desired. The steps for shortening or extending can be combined as desired. Another embodiment is the recombination of genes coding for functional domains of proteins, in an analogous manner to exon shuffling.

FIG. 17 shows a set of N-terminal (A), C-terminal (B) or internal (C) deletion mutants for the functional genome analysis, obtainable by methods according to FIGS. 15, 15a and 16. For instance a grid-type arrangement with primers successively containing the sequence of a gene in a form displaced by three nucleotides can serve by horizontal copying (see FIG. 9 and FIG. 15a) for the preparation of a grid-type arrangement containing a complete set of N or C-terminal deletions. These deletion mutants can thus be tested functionally and in parallel. Single N or C-terminal deletions can then be used according to FIG. 17 for the preparation of internal deletions.

FIG. 18 describes a method for the in-situ recombination of genetic elements. the method according to the invention can be combined as desired with methods known in the art for the in-vitro recombination and transfection. The addition of a vector or of several vectors (e.g. vectors for the different tissue-specific expression) is possible.

FIG. 19 and FIG. 20 show a use of the method for transferring a nucleic acid library to a surface (preparation of gene chips). It permits the preparation of a nucleic acid library chip with an areal porous or non-porous support, the grid area of the nucleic acid library according to the invention being brought into a direct or indirect areal contact with the support, and mobilized nucleic acids being simultaneously transferred from the grid elements to the support, maintaining the two-dimensionally resolved order of the nucleic acid library. The transfer can be performed by means of a method selected from the group comprised of “migration in an electric field, migration in a magnetic field, centrifugation, pressure difference and combinations of these methods”. The step D can repeated as often as desired, in order to achieve a maximum loading of the support.

FIG. 20 shows an embodiment of the method described in FIG. 19 under application of an electric field. This embodiment of the method can also be used for conditionally immobilized proteins or peptides.

FIG. 21 shows a device for a parallel flow through one (D) or any number of grid-type arrangements by using a nucleic acid library or protein or peptide library according to the invention in a method for processing, in particular cloning or copying, nucleic acids or for investigating the interactions between molecules, the grid elements of the nucleic acid library or protein or peptide library being passed in parallel by a solution containing reagents and/or prospectively interacting molecules, the following arrangement being made: a pressure block (A) in the form of a point mask with a single passage opening, a distributor mask (B), preferably with an equidistant distribution path arrangement with regard to a removal point and in a plane in parallel to the grid area, as an option a cover mask (C), the nucleic acid library (D) or the protein or peptide library with grid elements open at both ends, as an option a cover mask (E), a distributor mask (F), preferably with an equidistant distribution path arrangement with regard to a removal point and in a plane in parallel to the grid area, a pressure block (G) in the form of a point mask with a single passage opening, the passage openings and the removal points preferably being in alignment with one another on a line orthogonally to the grid area, and the passage opening of the pressure block (A) being subjected to a volume flow of the solution taken from the passage opening of the pressure block (G). The supply and the discharge may also take place by a single one of the two pressure blocks, it then has two openings, and the other one does not have an opening. A corresponding passage or return through cover masks and grid-type arrangement(s) has of course to be provided. The passage openings and the removal points are arranged in the region of the projection of the grid area in a direction orthogonally to the grid area, the cover masks comprising cover mask openings being in alignment with all grid elements of the library. The device can be used in detail for a parallel processing, such as for instance cloning according to FIG. 7, copying according to FIG. 8 or parallely detecting molecule interactions. Liquids or gases are guided through the pressure block (A) to the distributor mask (B), to the cover mask (C), to the grid-type arrangement (D), to the cover mask (E), to the distributor mask (F) and finally through the pressure block (G). The supply and discharge of the liquids or gases can also be performed at the distributor masks. The distributor masks preferably have equidistant distribution paths. By pressure on the blocks (A) and (G), a lateral escape of the liquids or gases is prevented. The device for a parallel flow-through has for certain applications (e.g. cloning nucleic acids with a small concentration or quantification of the gene expression by hybridization) the disadvantage that a certain molecule will come into contact with one grid element only. This disadvantage may be prevented by frequently mixing and returning the liquids or gases. With the device, interactions of the molecules with one another (e.g. nucleic acids or proteins with one another or nucleic acid with proteins/peptides or other molecule classes, such as hydrocarbons, lipids or low-molecular substances). The analyte is supplied to the grid-type arrangement in a detectable form (e.g. fluorescent, luminescent or isotope-marked). In the grid-type arrangement, nucleic acids or proteins/peptides or products of enzymatic reactions are present in an immobilized form. When a specific complex is formed, a specific interaction can be associated by a measurement. Alternatively, a complex can be examined, one component of the complex being immobilized, the other one being marked. When the analyte is driven out, measurable signals are generated. This embodiment serves for instance for the identification of receptor antagonists. The use of several superimposed grid-type arrangements (D) permits the simultaneous detection of group interactions. The interactions of proteins in the field of the functional genomics can thus be detected in a quicker way than with prior art methods. For instance, a human cDNA library can be permutated according to the method described in FIG. 11. The permutated grid-type arrangements are expressed according to the method described in FIG. 3, the proteins being marked (e.g. radioactively) and conditionally immobilized (e.g. His-tag) (human donor library). Several (for instance 100) of the permutated donor grid-type arrangements are then brought into contact in the device with a receptor grid-type arrangement coated with immobilized human proteins. After addition of a liquid terminating the conditional immobilization (e.g. Ni2⁺ ions), the mobilized proteins of the donor grid-type arrangements can interact with the immobilized proteins in the receptor grid-type arrangement. After washing and measuring the receptor grid-type arrangement thus simultaneously the interaction of all receptor proteins with 100 donor proteins each can be detected. Further, for instance the human donor library can be brought into contact with receptor grid-type arrangements of arbitrary viruses, prokaryotes or eukaryotes. This approach permits the quick identification of viral, prokaryotic or eukaryotic nucleic acids, proteins or peptides being able to undergo an affinitive and specific interaction with human proteins and thus being potential candidates for the diagnostics and drugs design. Further the donor libraries can be brought into contact with combinatorial nucleic acid, protein or peptide libraries. The nucleic acids, proteins or peptides can further be randomized in partial regions only. In another embodiment, human proteins are randomized in cavities which cannot be penetrated by human antibodies. Although in this approach the obstacle for the successful identification of candidates is higher, the probability is lower that the diagnostics and drugs candidates may cause adverse immune reactions in the patient.

FIG. 22 describes a device for a sequential flow through one or more matrices by using a nucleic acid library or peptide or protein library according to the invention in a method for processing, in particular cloning or copying, nucleic acids or for investigating the interactions between molecules, the grid elements of the nucleic acid library or protein or peptide library being serially passed by a solution containing reagents and/or prospectively interacting molecules, the following arrangement being made: a pressure block (G) without a passage opening, a distributor mask (F) with channels respectively connecting two grid elements of the library, said channels extending in a plane in parallel to the grid area, as an option a cover mask (E), the nucleic acid library (D) or the protein or peptide library with grid elements being open at both sides, as an option a cover mask (C), a distributor mask (B), with channels respectively connecting two grid elements of the library, said channels extending in a plane in parallel to the grid area, the channels of the distributor mask (B) only connecting such grid elements with one another which are not connected with one another by the distributor mask (F), and the distributor mask (B) having an inlet opening and an outlet opening connected to one grid element only, a pressure block (A) with two passage openings respectively connected with the inlet opening and the outlet opening of the distributor mask (B), the passage openings and the inlet and outlet openings preferably being in alignment with one another on a line orthogonally to the grid area, and the passage opening of the pressure block (A) connected with the inlet opening of the distributor mask (B) being subjected to a volume flow of the solution taken from the passage opening of the pressure block (A) connected with the outlet opening of the distributor mask (B). Alternatively, the supply and discharge may also take place corresponding to FIG. 21 on both sides of the overall arrangement. The passage openings and the inlet and outlet openings are arranged in the region of the projection of the grid area in a direction orthogonally to the grid area, the cover masks, if provided, comprising cover mask openings being in alignment with all grid elements of the library. The sequential flow through the matrix has the advantage that the grid elements are successively passed. Liquids or gases are guided back through the pressure block (A) to the distributor mask (B), to the cover mask (C), to the grid-type arrangement (D), to the cover mask (E), to the distributor mask (F) and finally through the pressure block (A). Here, too, the supply and discharge of the liquids or gases can also be performed at the distributor masks. By pressure on the blocks (A) and (G), a lateral escape of the liquids or gases is prevented. The sequential flow has the further advantage, compared to the parallel flow, that any number of grid elements of a grid-type arrangement can be brought into contact with one another, the sequence of the interactions being controlled by arbitrarily shaped distributor masks. Thereby for instance the specificities of the molecule interaction can be investigated. For instance an identified diagnostics or drugs candidate (nucleic acid, protein, peptide, but also any other molecules) can be brought into contact with grid-type arrangements of a human, expressed cDNA library and potential permutations of the library. According to the device described in FIG. 21, several grid-type arrangements (D) can simultaneously be tested. The specificity of the interaction can thus quickly be tested in the context of the human genome. Further, by variation of the flow rate and frequent mixing and returning of the liquids or gases, the kinetic and thermodynamic parameters of the interaction can completely be detected.

FIG. 23 shows a device for a parallel flow through one or any number of grid-type arrangements under simultaneous measurement in real time. Basically the device corresponds to that of FIG. 21. The passage openings and the removal points are however arranged outside the region of the projection of the grid area in a direction orthogonally to the grid area, the cover masks and the pressure blocks comprising openings in alignment with all grid elements of the library and between the pressure blocks and the distributor masks in addition preferably transparent one-hole masks being provided, the holes of the one-hole masks respectively connecting the passage openings and the removal points to one another. Here, too, alternatively a return through the components A to D may take place, and the components F and G have thus no passage opening. The device is preferably used for the quantification of the gene expression and quantification of molecule interactions.

FIG. 24 describes a device corresponding to FIG. 22, however for the sequential flow through one or any number of grid-type arrangements under simultaneous measurement in real time. Real-time measurement here and in FIG. 23 means for instance the analysis by means of optical methods by transmission or excitation from one side and analysis from the other side. The transparency of the one or two-hole masks must be adjusted to the radiation used for the analysis. The passage openings and the inlet and outlet openings are arranged outside the region of the projection of the grid area in a direction orthogonally to the grid area, the cover masks and the pressure blocks comprising openings in alignment with all grid elements of the library, and between the pressure blocks and the distributor masks in addition preferably transparent one or two-hole masks being provided, the holes of the one or two-hole masks respectively connecting the passage openings and the associated inlet or outlet opening to one another.

The device is preferably used for the quantification of molecule interactions in the context of competing interactions.

FIG. 25 shows an embodiment of the invention for parallely sequentiating nucleic acids, proteins or peptides. In this method, the sequential synthesis or degradation of the molecules is used. Nucleic acid sequentiation: the taken-up primer can partially be extended with only one, two or three added nucleoside triphosphates or substances being analogous thereto. This step can be used for the parallel sequentiation of all nucleic acid grid elements. Successive, identical nucleotide positions can be detected by the intensity of the integration reaction. In a preferred embodiment of the invention, conditional terminators are used. In an analogous approach, protein matrix elements can be sequentiated by Edmann degradation.

In addition to the introduction of the nucleic acid by means of the methods described above, they can also be introduced into the grid elements by aerosols. For this purpose, the solution to be introduced into the grid elements is vaporized and transported through or into the grid elements by a gas flow.

Not shown in the figures is the possibility of the immobilization of the counter-strand by a vertical or horizontal copy. Further is not shown the transfer of gene products by a vertical or horizontal copy. This prevents disturbing signals by the presence of nucleic acids. Example: biotin labeling of RNA or protein, binding to avidin/streptavidin.

1. A nucleic acid library or protein or peptide library in the form of a two-dimensionally resolved grid-type arrangement with a plurality of grid elements, every grid element containing, on the statistical average, a defined number of nucleic acid types or protein or peptide types having a respective specific sequence structure, wherein the grid elements are configured as capillary hollow spaces with at least one opening at one end, the capillary axes of the capillary hollow spaces being in parallel to one another and the openings of different capillary hollow spaces being arranged in a preferably planar grid area with a uniform grid dimension of the openings.

2. A nucleic acid library or protein or peptide library according to claim 1, wherein the grid elements are configured as capillary hollow spaces of a substantially cylindrical shape, and wherein the capillary axes are preferably orthogonal to the grid area.

3. A nucleic acid library or protein or peptide library according to claim 1 or 2, wherein the ratio of length to width of the capillary hollow spaces is in the range from 2 to 500, preferably from 2 to 20, most preferably from 5 to 10.

4. A nucleic acid library or protein or peptide library according to one of claims 1 to 3, wherein the width of the capillary hollow spaces is in the range from 0.1 μm to 1,000 μm, preferably from 0.1 μm to 100 μm, most preferably from 0.1 μm to 10 μm.

5. A nucleic acid library or protein or peptide library according to one of claims 1 to 4, wherein the lateral density of the grid elements is in the range from 1/mm² to 10⁸/mm², preferably from 10²/mm² to 10⁸/mm², most preferably from 10⁴/mm² to 10⁸/mm².

6. A nucleic acid library or protein or peptide library according to one of claims 1 to 5, wherein the capillary hollow spaces are open at both ends, and the respectively opposite openings form mutually parallel grid areas.

7. A nucleic acid library or protein or peptide library according to one of claims 1 to 6, wherein the structural material of the grid elements is selected from the group comprised of “metallic materials, surface-passivated metallic materials, ceramic materials, glasses, polymeric materials and combinations of these materials”.

8. A nucleic acid library or protein or peptide library according to one of claims 1 to 7, wherein the grid elements are surface-modified by anchoring sites, preferably by covalent binding sites, for nucleic acids or proteins or peptides.

9. A method for preparing a nucleic acid library in the form of a two-dimensionally resolved grid-type arrangement with a plurality of grid elements, every grid element containing, on the statistical average, a defined number of nucleic acid types having a specific sequence information, and wherein fluids brought into different grid elements do not communicate with one another, comprising the following steps:
a) a two-dimensional grid-type arrangement of grid elements configured as hollow spaces comprising openings is generated,
b) the openings of the hollow spaces are brought into contact with a solution containing nucleic acids, under co-operation of capillary forces a partial amount of the solution being sucked into every grid element,
c) the openings of the hollow spaces are separated from the solution,
d) a drying step is performed,
e) and as an option the grid-type arrangement as a whole is subjected to an amplification step,
the concentration of the nucleic acids in the solution and the dimensioning of the hollow spaces and the openings thereof with regard to the size of the partial amount sucked into a grid element being mutually adjusted such that the partial amount of solution sucked into a grid element contains, on the statistical average, a defined number of nucleic acid molecules.

10. A method for copying a nucleic acid library according to one of claims 1 to 8 or obtainable according to claim 9, wherein all or a part of the grid elements of a grid-type arrangement loaded with nucleic acids and all or a part of the grid elements of an empty grid-type arrangement are connected to one another with their respective openings in a defined mutual orientation with regard to the two-dimensional position resolution, then either a) if necessary a mobilization of the nucleic acids in the loaded grid-type arrangement being performed, b) a reaction solution for an amplification step being brought into the grid elements connected to one another of the two grid-type arrangements, and c) an amplification step being performed, or then a transfer of nucleic acids into connected grid elements of the empty grid-type arrangement being performed by a′) if necessary a mobilization of the nucleic acids in the loaded grid-type arrangement, and b′) a transport of the mobilized nucleic acids from the loaded grid-type arrangement into the empty grid-type arrangement, wherein then the two grid-type arrangements are separated from one another, and as an option prior to or after the separation an immobilization of the nucleic acids in the previously empty grid-type arrangement is performed.

11. A method according to claim 10, wherein only a part of the grid elements of the loaded grid-type arrangement are connected with a part of the grid elements of the empty grid-type arrangement by interposition of a grid mask between the two grid-type arrangements, the number of grid passage openings of the grid mask being smaller than the number of the grid elements of the loaded grid-type arrangement.

12. A method according to claim 11, wherein the step of the connection of a part of the grid elements of the grid-type arrangements is repeated, and wherein prior to every repetition the grid mask and/or one or both of the grid-type arrangements are displaced by a defined path being an integral multiple n=1, 2, 3, etc. of the center distance of adjacent grid elements in the direction in parallel to the grid area.

13. A method according to claim 10, wherein firstly a plurality of identical grid-type arrangements loaded with nucleic acids and having an identical lateral grid dimension of the grid elements are prepared, these grid-type arrangements being arranged side by side, preferably such that the grid dimension of the grid-type arrangements after arranging them side by side is continuously growing over connection regions of adjacent grid-type arrangements, one, several or all grid elements of an empty grid-type arrangement with a preferably identical grid dimension being connected with corresponding grid elements of the nucleic acid-loaded grid-type arrangements arranged side by side.

14. A method according to one of claims 10 to 13, wherein the grid-type arrangement loaded with nucleic acids and the empty grid-type arrangement have a different grid dimension, and wherein the connection of the grid elements takes place under interposition of at least one reduction mask or enlargement mask.

15. A method according to claim 10, wherein a single connection, for instance by a capillary, between a grid element of the loaded grid-type arrangement and a grid element of the empty grid-type arrangement is generated, and wherein by subsequent defined lateral displacement of the single connection and/or of one and/or both grid-type arrangements, the grid elements of the empty grid-type arrangement are successively loaded with nucleic acids from the grid elements of the loaded grid-type arrangement.

16. A method according to claim 10, wherein between the loaded grid-type arrangement and the empty grid-type arrangement are interposed the following components:
a) as an option a cover mask,
b) a distributor mask, preferably with an equidistant distribution path arrangement with regard to a removal point and in a plane in parallel to the grid area,
c) a point mask with a single passage opening,
d) a distributor mask, preferably with an equidistant distribution path arrangement with regard to a removal point and in a plane in parallel to the grid area, and
e) as an option a cover mask,
the removal points of the distributor masks being connected with the passage opening of the point mask, a transfer of the nucleic acids of a grid element of the loaded grid-type arrangement to a grid element of the empty grid-type arrangement being achieved by that the selected grid element of the loaded grid-type arrangement is subjected to a fluid flow and that simultaneously the selected grid element of the empty grid-type arrangement is switched-over so that the fluid flow can pass through, and wherein if necessary the steps of providing the fluid flow and switching-over to passing-through are repeated for desired different grid elements of the two grid-type arrangements.

17. The use of a nucleic acid library or protein or peptide library according to one of claims 1 to 8 or obtainable according to claim 9 in a method for processing, in particular cloning or copying, nucleic acids or for investigating the interactions between molecules, the grid elements of the nucleic acid library or protein or peptide library being passed in parallel by a solution containing reagents and/or prospectively interacting molecules, the following arrangement being made:
a) a pressure block in the form of a point mask with a single passage opening,
b) a distributor mask, preferably with an equidistant distribution path arrangement with regard to a removal point and in a plane in parallel to the grid area,
c) as an option a cover mask,
d) the nucleic acid library or the protein or peptide library with grid elements open at both ends,
e) as an option a cover mask,
f) a distributor mask, preferably with an equidistant distribution path arrangement with regard to a removal point and in a plane in parallel to the grid area,
g) a pressure block in the form of a point mask with a single passage opening,
the passage openings and the removal points preferably being in alignment with one another on a line orthogonally to the grid area, and the passage opening of the pressure block a) being subjected to a volume flow of the solution taken from the passage opening of the pressure block g).

18. The use according to claim 17, wherein the passage openings and the removal points are arranged in the region of the projection of the grid area in a direction orthogonally to the grid area, and wherein the cover masks, if provided, comprise cover mask openings being in alignment with all grid elements of the library.

19. The use according to claim 17, wherein the passage openings and the removal points are arranged outside the region of the projection of the grid area in a direction orthogonally to the grid area, and wherein the cover masks, if provided, and the pressure blocks comprise openings in alignment with all grid elements of the library and wherein between the pressure blocks and the distributor masks in addition preferably transparent one-hole masks are provided, the holes of the one-hole masks respectively connecting the passage openings and the removal points to one another.

20. The use of a nucleic acid library or peptide or protein library according to one of claims 1 to 8 or obtainable according to claim 9 in a method for processing, in particular cloning or copying, nucleic acids or for investigating the interactions between molecules, the grid elements of the nucleic acid library or protein or peptide library being serially passed by a solution containing reagents and/or prospectively interacting molecules, the following arrangement being made:
a) a pressure block without a passage opening,
b) a distributor mask with channels respectively connecting two grid elements of the library, said channels extending in a plane in parallel to the grid area,
c) as an option a cover mask,
d) the nucleic acid library or the protein or peptide library with grid elements being open at both sides,
e) as an option a cover mask,
f) a distributor mask, with channels respectively connecting two grid elements of the library, said channels extending in a plane in parallel to the grid area, the channels of the distributor mask f) only connecting such grid elements with one another which are not connected with one another by the distributor mask b), and the distributor mask f) having an inlet opening and an outlet opening connected to one grid element only,
g) a pressure block with two passage openings respectively connected with the inlet opening and the outlet opening of the distributor mask f),
the passage openings and the inlet and outlet openings preferably being in alignment with one another on a line orthogonally to the grid area, and the passage opening of the pressure block g) connected with the inlet opening of the distributor mask f) being subjected to a volume flow of the solution taken from the passage opening of the pressure block g) connected with the outlet opening of the distributor mask f).

21. The use according to claim 20, wherein the passage openings and the inlet and outlet openings are arranged in the region of the projection of the grid area in a direction orthogonally to the grid area, the cover masks, if provided, comprising cover mask openings being in alignment with all grid elements of the library.

22. The use according to claim 20, wherein the passage openings and the inlet and outlet openings are arranged outside the region of the projection of the grid area in a direction orthogonally to the grid area, the cover masks, if provided, and the pressure blocks comprising openings in alignment with all grid elements of the library, and between the pressure blocks and the distributor masks in addition preferably transparent one or two-hole masks being provided, the holes of the one or two-hole masks respectively connecting the passage openings and the associated inlet or outlet opening to one another.

23. The use of a nucleic acid library according to one of claims 1 to 8 for the preparation of a protein or peptide library, wherein into the grid elements of the nucleic acid library an expression mix is brought, and the expression reactions are performed.

24. The use of a nucleic acid library according to one of claims 1 to 8 for the preparation of a nucleic acid library chip with an areal porous or non-porous support, the grid area of the nucleic acid library being brought into a direct or indirect areal contact with the support, and mobilized nucleic acids being simultaneously transferred from the grid elements to the support, maintaining the two-dimensionally resolved order of the nucleic acid library.

25. The use according to claim 24, wherein the transfer takes place by means of a method selected from the group comprised of “migration in an electric field, migration in a magnetic field, centrifugation, pressure difference and combinations of these methods”.

26. The use according to one of claims 24 or 25, wherein the support is made from a material selected from the group comprised of “metalloid materials, metallic materials, ceramic materials, glasses, polymeric materials and combinations of these materials”.

27. The use of a nucleic acid library or of a protein or peptide library according to one of claims 1 to 8 or obtainable according to claim 9 for sequentiating the nucleic acids, proteins or peptides present in the grid elements, the nucleic acids or peptides or proteins being synthesized or decomposed by addition or degradation of a structural element repeated in cycles, and in every cycle sequence information being gained.
